(19) United States
(12) Patent Application Publication
(10) Pub. No.: US 2007/0230473 A1
(43) Pub. Date: Oct. 4, 2007

(54) Communication device

(75) Inventors: Masahiro Nishiyama, Osaka (JP); Yoshiaki Yasui, Osaka (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 11/727,793

(22) Filed: Mar. 28, 2007

(30) Foreign Application Priority Data
Mar. 31, 2006 (JP) JP 2006-097699

(51) Int. Cl. H04L 12/56

(52) U.S. Cl. 370/392; 370/401

(57) ABSTRACT

A communication device 1 that communicates with other devices connected to a communication network includes an operation unit 12b, a memory 14, a determination unit 15a, and a display unit 12a. The operation unit 12b receives the input of an IP address from the exterior. The memory 14 stores a private address assigned to another device on the intranet 6. The determination unit 15a determines whether or not the IP address received by the operation unit 12b agrees with the private addresses that are stored. The display unit 12a displays that the IP address received by the operation unit 12b does not agree with the private addresses when determined by the determination unit 15a.

### CROSS-REFERENCE TO RELATED APPLICATIONS

This application claims priority to Japanese Patent Application No. 2006-097699 filed on Mar. 31, 2006. The entire disclosure of Japanese Patent Application No. 2006-097699 is hereby incorporated herein by reference.

### BACKGROUND OF THE INVENTION

1. Field of the Invention

The present invention generally relates to a communication device. More specifically, the present invention relates to a communication device that is able to communicate with other devices that are connected to a communication network.

2. Background Information

Recent communication devices include image forming devices such as fax machines, printers, copying machines, and the like having a communication function, other than personal computers, mobile devices, and the like. This kind of communication device is assigned a specific IP (Internet Protocol) address, and is able to send and to receive various kinds of information with externally connected devices in an environment in which the communication device is connected to be able to communicate with externally connected devices via an IP network.

When the above described communication device receives an information transmission command with an IP address specified that indicates the destination for sending the information from a user, the information is transmitted to the specified IP address.

In addition, as for devices that are related to the above described communication device, for example, the one shown in Japanese Patent Application Publication No. 2000-207323 has been proposed.

Meanwhile, since there are not any limitations and the like with respect to the range of the specified IP address in the above described communication device, when a user specifies a wrong IP address, information will be transmitted to the specified wrong IP address. As a result, information may be transmitted to unintended parties. Particularly, when the information to be transmitted is secret or confidential information that can be disclosed only in the network that belongs to one's own device, such as an information leak becomes a serious problem.

In addition, in order to protect information in the network from unauthorized access and the like, in a recent communication device, often times a fire wall or the like is installed to enhance security. However, depending on the setting of the level of security, even if information is transmitted to another device outside of the network that belongs to one's own device, information may actually not be received by the designated device.

In view of the above, it will be apparent to those skilled in the art from this disclosure that there exists a need for an improved communication device. This invention addresses this need in the art as well as other needs, which will become apparent to those skilled in the art from this disclosure.

### SUMMARY OF THE INVENTION

In light of the aforementioned problems, the present invention provides a communication device that prevents information from being transmitted to a destination a user has mistakenly specified, and at the same time, when a user executes a transmission command to send information in the communication device, the communication device prevents information from not reaching the designated device in reality, i.e., from being blocked due to a fire wall or the like.

A communication device according to a first aspect of the present invention communicates with other devices connected to a communication network, and includes a designation receiving unit, a memory, a determination unit, and an annunciation unit. The designation receiving unit is configured to receive the specification of an IP (Internet Protocol) address from the outside. The memory is configured to store private addresses assigned to other devices on the communication network. The determination unit is configured to determine whether or not the IP address received by the designation receiving unit and the private addresses agree with each other. The annunciation unit is configured to annunciate that the IP address received by the designation receiving unit does not agree with the private address, when this is determined by the determination unit.

This communication device notifies the user that information is going to be sent to an IP address that is not a private address when the inputted IP address is not a private address. Therefore, it is possible to prevent a user from mistakenly sending information to a global address, which is not a private address, resulting in an information leak. In addition, it is possible to prevent information from not reaching the designated device in reality, i.e., being blocked from reaching the designated device, due to a fire wall and the like, even though a user has made a transmission command to the communication device to send the information.

A communication device according to a second of the present invention is the communication device of the first aspect, wherein the annunciation unit is a display unit configured to display the IP address received by the designation receiving unit in a predetermined color, and at the same time display the IP address received by the designation receiving unit in a color different from the predetermined color, when it does not agree with the private address.

As a result, a user will be able to know that the inputted IP address is a global address and not a private address.

A communication device according to a third aspect of the present invention communicates with other devices connected to a communication network, and includes a designation receiving unit, a memory, a network address specification unit, a determination unit, and an annunciation unit. The designation receiving unit is configured to receive the specification of an IP address from the outside. The memory is configured to store a network address of its own device. The network address specification unit is configured to specify a network address corresponding to the IP address based on the IP address received by the designation receiving unit. The determination unit is configured to determine whether the network address specified by the network address specification unit and the network address of its own device that is stored by the memory agree with each other or not. The annunciation unit is configured to annunciate that the network address specified and the network address of its own device do not agree with each other when this is determined by the determination unit.

This communication device notifies the user that information is going to be transmitted outside of the network of its own device when the inputted IP address is an address of a device outside the network that belongs to its own device. Therefore, it is possible to prevent a user from mistakenly transmitting information to a device in another network resulting in an information leak. In addition, it is possible to prevent information from not reaching or being blocked from reaching a designated device in reality due to a fire wall and the like, even though a user has made a transmission command in the communication device to send the information.

A communication device according to a fourth aspect of the present invention is the communication device of the third aspect, wherein the annunciation unit is a display unit configured to display the IP address received by the designation receiving unit in a predetermined color, and at the same time display the IP address received by the designation receiving unit in a color different from the predetermined color when the network address specified by the network address specification unit and the network address of its own device stored by the memory do not agree with each other. As a result, a user will be able to know that the inputted IP address is an address of a device outside the network of its own device.

According to the communication device of the present invention, since a user is prevented from mistakenly transmitting information to a specified destination, it is possible to prevent information leaks. Furthermore, according to the communication device of the present invention, it is possible to prevent information from not reaching or being blocked from reaching a designated device in reality due to a fire wall and the like, even though a user has made a transmission command in the communication device to send the information. Therefore, it is possible to reduce unnecessary communication in the communication network.

These and other objects, features, aspects, and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a view of a configuration diagram of a communication system using an IP FAX adopted to be the communication device in accordance with a first preferred embodiment of the present invention;

FIG. 2 is a view of a block diagram showing the configuration of the IP FAX of the first embodiment;

FIG. 3 is a view of a configuration diagram and an example of a screen of an operation panel of the IP FAX of the first embodiment;

FIG. 4 is a view of a concept explanation diagram of a private address list stored by a memory of the IP FAX of the first embodiment;

FIG. 5 is a view of an example of a screen of the operation panel of the first embodiment;

FIG. 6 is a view of a flowchart explaining the operation of the IP FAX of the first embodiment;

FIG. 7 is a view of a block diagram showing the configuration of an IP FAX adopted to be the communication device in accordance with a second preferred embodiment of the present invention; and

FIG. 8 is a view of a flowchart explaining the operation of the IP FAX of the second embodiment.

FIG. 9 is an example of a screen of the operation panel in the second embodiment.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### First Embodiment

### (1) Configuration of a Communication System

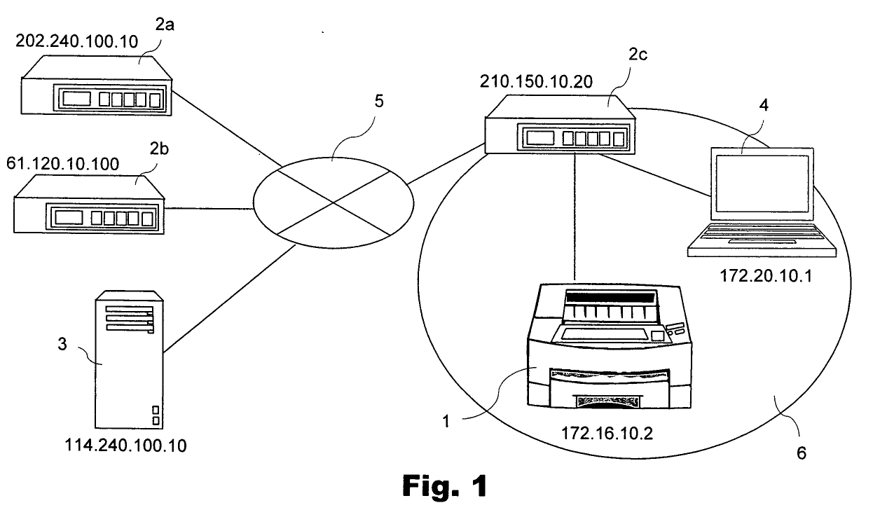

FIG. 1 is a view of a configuration diagram of a communication system used in a communication device according to a preferred embodiment of the present invention. This communication system includes routers 2a to 2c, a server 3, an IP FAX 1 adopted to be the communication device of the present invention, and a computer 4.

The routers 2a to 2c and the server 3 are connected via the Internet 5, each having an official IP address in the Internet 5, or a so-called global address. Each of routers 2a and 2b is connected to devices such as a computer or the like, not shown in the figure, or an image forming device that is able to communicate, such as an IP FAX or the like.

The IP FAX 1 and the computer 4 are devices on the intranet 6, and are able to communicate with each of the devices connected to the server 3 and the other routers 2a and 2b through the router 2c and the Internet 5 that are connected. In the IP FAX 1 and the computer 4, an IP address, or a so-called private address, is assigned that can be used only within the intranet 6.

In addition, “210.150.10.20” and the like in FIG. 1 represent the IP addresses assigned to each device.

### (2) Configuration of the IP FAX

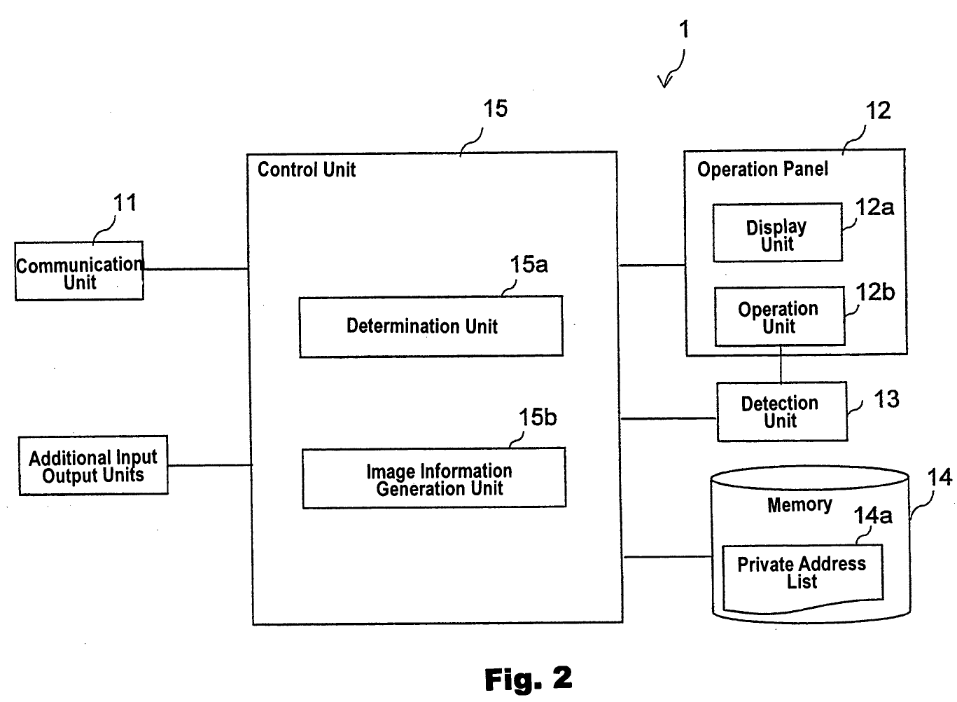

FIG. 2 is a view of a block diagram showing the configuration of the IP FAX 1 in FIG. 1. IP FAX 1 includes a communication unit 11, an operation panel 12, a detection unit 13, a memory 14, a control unit 15, and additional input output units. The additional input output units have a scan unit that scans an image, a paper feeding unit, and the like.

The communication unit 11 is a device that allows the IP FAX 1 to communicate with the other devices on the Internet 5 and the intranet 6, for example, transmitting information of image data and the like to a specified IP address.

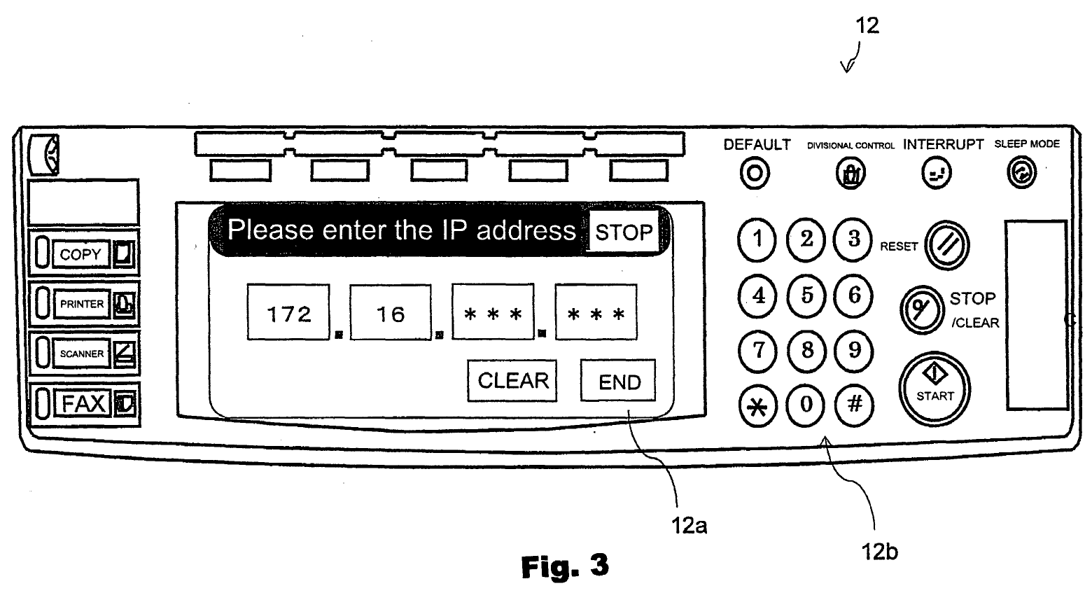

The operation panel 12 includes a display unit 12a (corresponding to an annunciation unit), and an operation unit 12b (corresponding to a designation receiving unit), as shown in FIGS. 2 and 3.

The display unit 12a is preferably made of a touch panel type of liquid crystal display, and displays based on the image information generated by an image information generation unit 15b (to be described later) of the control unit 15. For example, the display unit 12a displays an image to allow a user to input an IP address of a destination, as shown in FIG. 3, and displays the IP address in a predetermined color after it is inputted.

The operation unit 12b includes a Start key to start the scanning of an original and to make a command to print the image data that are received, setting keys for various settings, a numeric keypad for the input of numerical values, and the like. An IP address is inputted by a user using the numeric keypad of the operation unit 12b when the display unit 12a is displaying the screen shown in FIG. 3.

The detection unit 13 detects when an IP address is inputted using the numeric keypad of the operation unit 12b.

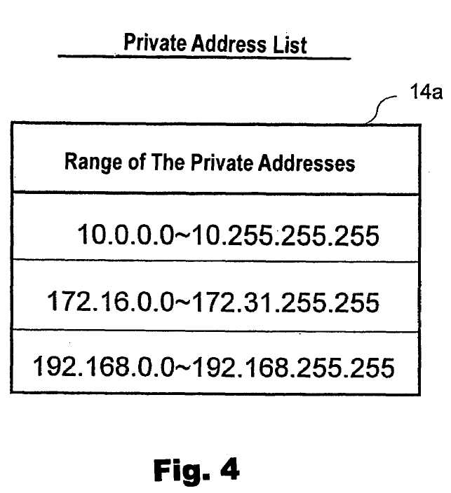

The memory 14 stores image data received from other devices, and various programs that are executed by the control unit 15, and stores a private address list 14a simultaneously. FIG. 4 is a view of a private address list used to explain the concept of the private address list 14a. The private address list 14a in FIG. 4 stores the range of the private addresses of other devices (hereinafter, simply referred to as “the range of addresses”) within the intranet 6.

Referring to FIGS. 2 and 3, the control unit 15 is made of a microcomputer having a CPU, and as shown in FIG. 2, it is connected to the communication unit 11, the operation panel 12, the detection unit 13, the memory 14, and the additional input output units. The control unit 15 executes the control of the operation of the input output units that are connected, and the like, and simultaneously determines whether it is appropriate to transmit information to the IP address that is inputted. In order to execute this kind of control, the control unit 15 functions as a determination unit 15a and as an image information generation unit 15b.

The determination unit 15a determines whether or not an IP address detected by the detection unit 13 is an IP address that falls into the range of addresses in the private address list 14a of the memory 14. In the present embodiment, in parallel with the IP address input operation of a user, the determination unit 15a determines whether or not each character of the IP address that is being inputted falls into the range of addresses in the private address list 14a.

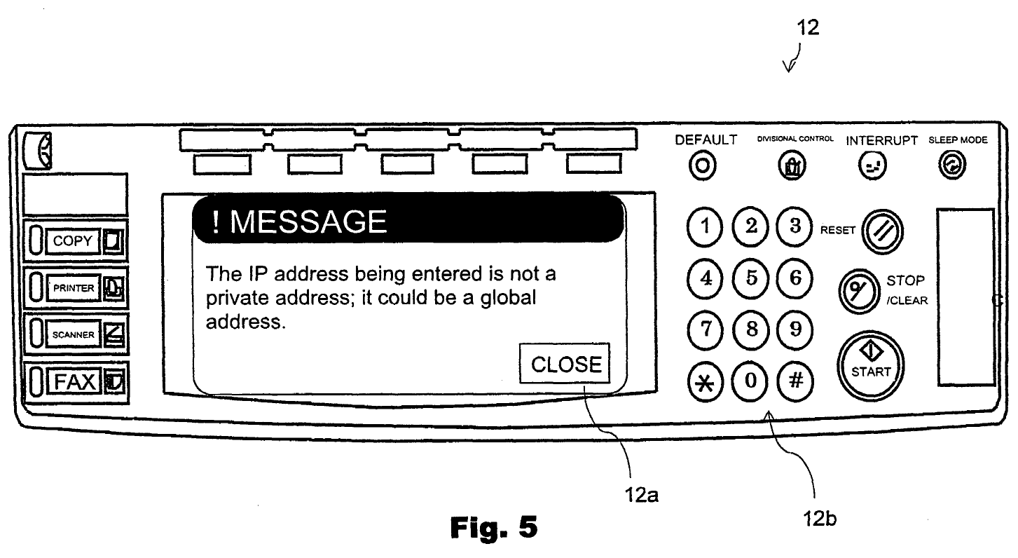

When the determination unit 15a determines that the IP address detected by the detection unit 13 does not fall into the range of addresses in the private address list 14a, regarding this, the image information generation unit 15b generates image information to be displayed on the display unit 12a as shown in FIG. 5, for example, and outputs it to the display unit 12a. In addition, in the present embodiment, a method of displaying a message as shown in FIG. 5, and a method of displaying an IP address inputted and one being inputted in different colors are used as methods of displaying that the IP address inputted does not fall into the range of addresses of the private address 14a.

### (3) Operation of the IP FAX

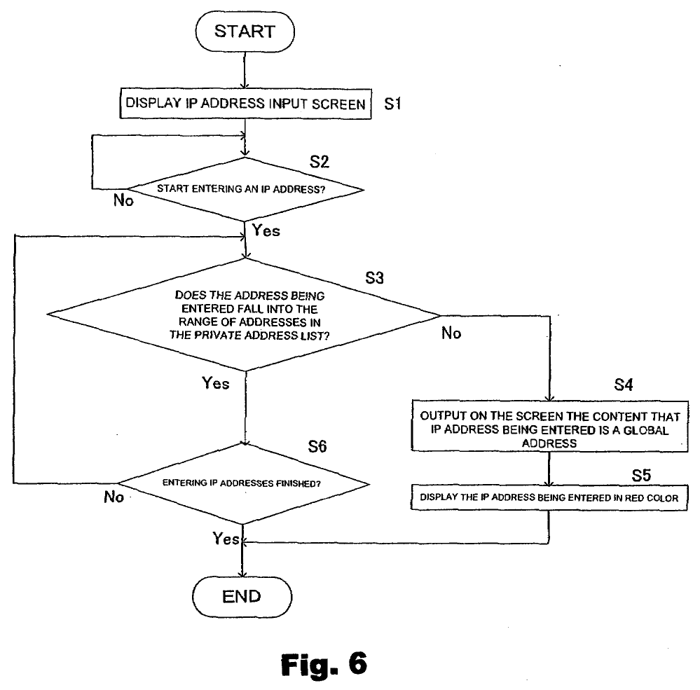

FIG. 6 is a flowchart used for explaining the operation of the IP FAX 1.

Step S1: Referring to FIGS. 2, 3, and 6, when a user selects the transmission function to send information of image data and the like, the image information generation unit 15b of the control unit 15 generates image information on the IP address input screen, and outputs it to the display unit 12a. The display unit 12a displays the screen shown in FIG. 3 based on this image information. In addition, this image information includes the content that IP address to be inputted will be displayed in black color.

Steps S2 and S3: When the user starts to input an IP address using the numeric keypad of the operation unit 12b, the display unit 12a will display the IP address being inputted in black color (S2). The detection unit 13 detects this, and outputs it to the control unit 15 (S2). The determination unit 15a of the control unit 15 determines whether or not the detected IP address being inputted falls into the range of addresses in the private address list 14a (S3).

Steps S4 and S5: Referring now to FIGS. 2, 3, 5, and 6, the determination unit 15a determines that the IP address being inputted does not fall into the any of the ranges within the range of addresses in the private address list 14a, the image information generation unit 15b generates image information to be displayed on the display unit 12a with the information that the IP address being inputted is a global address and not a private address, and outputs it to the display unit 12a (S4). The display unit 12a displays a screen shown in FIG. 5. After that, the image information generation unit 15b generates image information to display the address being inputted in red color, and outputs it to the display unit 12a (S5). The display unit 12a displays the screen in FIG. 3 again. However, it will display the IP address being inputted in red color on the screen in FIG. 3.

Step S6: In Step S3, when the determination unit 15a determines that the IP address being inputted falls into any of the ranges within the range of addresses in the private address list 14a, and the user has not completed the IP address input operation and wishes to enter more addresses, IP FAX 1 will repeat the operations after Step S3. When the IP address input operation has been completed, the IP FAX 1 will terminate the series of operations.

### (4) Effect

In this IP FAX 1, when the IP address inputted is not a private address, the inputted IP address is determined to be a global address, and the user is informed that information is going to be transmitted to a global address. Therefore, it is possible to prevent the leak of information due to a user mistakenly transmitting information to a global address. In addition, it is possible to prevent information from not reaching the designated device in reality due to a fire wall and the like, even if an information transmission command was made by a user.

In addition, the IP FAX 1 displays the inputted IP address in a color such as black and the like, for example. In the case that the inputted IP address disagrees with private addresses, the inputted IP address is displayed in a color different from the black color (for example red color). As a result, a user will be able to know that the inputted IP address is a global address and not a private address.

### Alternate Embodiments

Alternate embodiments will now be explained. In view of the similarity between the first and alternate embodiments, the parts of the alternate embodiments that are identical to the parts of the first embodiment will be given the same reference numerals as the parts of the first embodiment. Moreover, the descriptions of the parts of the second embodiment that are identical to the parts of the first embodiment may be omitted for the sake of brevity.

### Second Embodiment

### (1) Configuration of the IP FAX

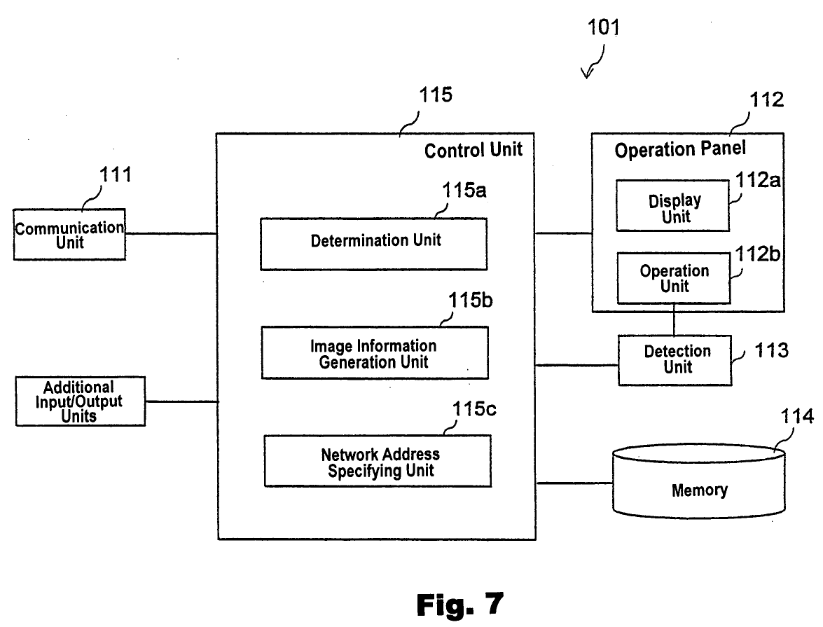

Next, initially referring to FIG. 7, an IP FAX 101 adopted to be the communication device according to a second preferred embodiment of the present invention will be described. This IP FAX 101 is able to communicate with other devices via a communication network, in a manner similar or identical to that of the IP FAX 1 of the first embodiment.

The IP FAX 101 further includes a network address specification unit 115c in the control unit 115, in addition to the configuration of the IP FAX 1. More specifically, the IP FAX 101 includes a communication unit 111, an operation panel 112, a detection unit 113, a memory 114, a control unit 115, and additional input output units, as shown in FIG. 7. The control unit 115 includes a determination unit 115a, an image information generation unit 115b, and network address specification unit 115c. In the following, parts on the operations or functions that are different from those of the IP FAX 1 of the first embodiment will be described.

The memory 114 stores network addresses of the device thereof.

When the detection unit 113 detects an IP address inputted by a user using the operation unit 112b, the network address specification unit 115c specifies a network address corresponding to the IP address, based on this detected IP address. Methods of specifying include a method in which each of the detected IP address and sub netmask is shown to be a 32 bit binary number, and the network address is obtained by calculating them with AND calculation. Other methods include a method in which the IP address is shown to be a 32 bit binary number, and after figuring out the bit value of the network address by the top three bit value, a network address is obtained.

The determination unit 115a determines whether or not the network address specified by the network address specification unit 115c agrees with the network address of its own device stored by the memory 114. In addition, the determination unit 115a of the present embodiment performs the above described operation, after the user has finished inputting the IP address.

When the determination unit 115a determined that the specified network address and the network address of its own device do not agree, the image information generation unit 115b generates image information in order to display this in the display unit 112a.

### (2) Operation of the IP FAX

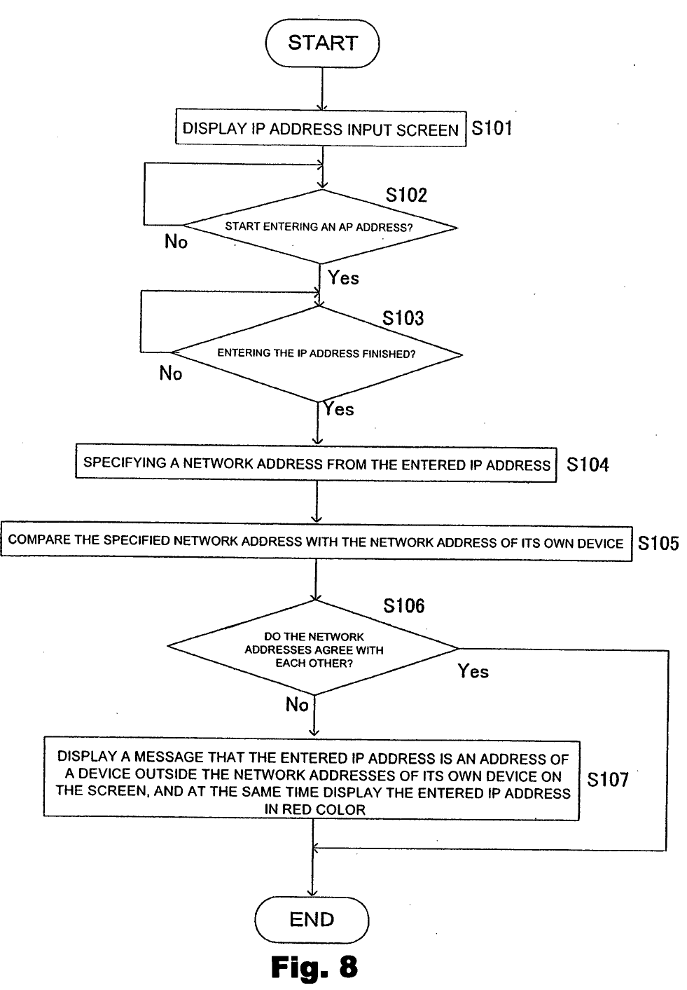

FIG. 8 is a flowchart used for explaining the operation of the IP FAX 101.

Step S101: When a user selects the transmission function to send image data information or the like, the image information generation unit 115b of the control unit 115 generates image information of the IP address input screen, and the display unit 112a displays the IP address input screen based on this image information. In addition, this image information includes the content that the IP address to be inputted is to be displayed in black color.

Steps S102 to S105: When the user starts to input an IP address using the numeric keypad of the operation unit 112b, the display unit 112a displays the inputted IP address in black color (S102). When the IP address is inputted and the detection unit 113 detects this (S103), the network address specification unit 115c of the control unit 115 specifies a network address corresponding to the IP address based on the detected IP address (S104). The determination unit 115a determines whether or not the specified network address and the network address of its own device agree with each other (S105). It should be apparent from this disclosure that multiple addresses can be entered at step S103.

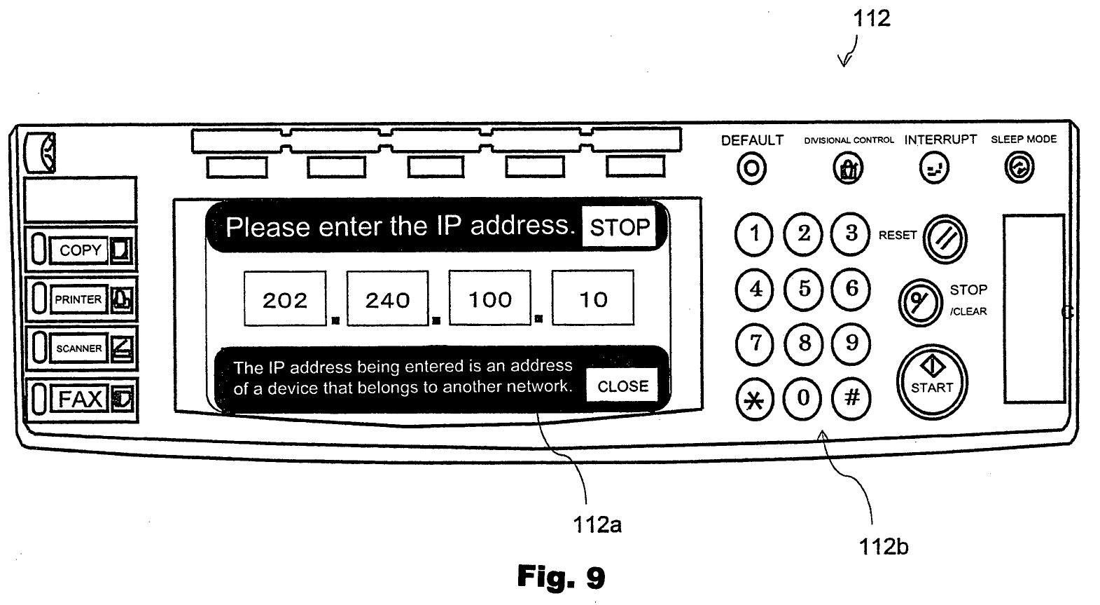

Steps S106 and S107: When the determination unit 115a determines that the specified network address and the network address of its own device do not agree, the image information generation unit 115b generates image information to display the inputted IP address in red color simultaneously while generating image information to display that the inputted IP address is an address of a device that is outside of the network of its own device, and outputs this to the display unit 112a (S106). The display unit 112a displays an image shown in FIG. 9 based on this image information. In addition, when the determination unit 115a determines that the specified network address and the network address of its own device agree with each other, the IP FAX 101 terminates the series of operations (S107).

### (3) Effect

This IP FAX 101 informs the user that information is transmitted to a device outside of the network of its own device, when the inputted IP address is an address of a device outside of the network that belongs to its own device. Therefore, this prevents a user from mistakenly transmitting information to a device outside of the network that belongs to its own device, and resulting in information leaks, and at the same time, it is able to prevent a case in which due to a fire wall or the like, information does not reach the designated device in reality, even though the user made a transmission command to send the information.

In addition, the IP FAX 101 displays the inputted IP address in a color such as black and the like, for example. Then, when the inputted IP address is an address of a device outside the network that belongs to its own device, the IP FAX 101 displays the inputted IP address in a color (for example red color) that is different from the black color. As a result, the user will be able to know that the inputted IP address is an address of a device outside the network of its own device.

### Other Embodiments

(a) In the first and the second embodiments, when notifying the user of the result determined by the determination unit, the determined result is displayed as a message, or the inputted IP address is displayed in a color different from the color of an IP address being inputted, as these are the cases described above. However, the notification is not particularly limited. Notification other than the above described includes, for example, notification via sound, a combination of sound and display, displaying the IP address to be counterturned, other colors, and the like.

(b) In the first and the second embodiments, a case in which a user uses a numeric keypad to input an IP address is described. However, a method in which a user registers IP addresses in a communication device in advance and specifies the intended IP address from the IP addresses that are registered is also acceptable.

(c) In the first embodiment, the memory stores the range of the private addresses. However, it may directly store each private address setup for each device, instead of the “range” configuration.

The communication device of the present invention is applicable to image forming devices such as fax machines, printers, copying machines and the like, having a communication function such as a PC, a mobile device, IP FAX, and the like.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

### GENERAL INTERPRETATION OF TERMS

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers, and/or steps. The foregoing also applies to words having similar meanings such as the terms, “including,” “having,” and their derivatives. Also, the terms “part,” “section,” “portion,” “member,” or “element” when used in the singular can have the dual meaning of a single part or a plurality of parts. As used herein to describe the present invention, the following directional terms “forward, rearward, above, downward, vertical, horizontal, below and transverse” as well as any other similar directional terms refer to those directions of a communication device of the present invention. Accordingly, these terms, as utilized to describe the present invention should be interpreted relative to a communication device of the present invention as normally used. Finally, terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A communication device configured to communicate with other devices connected to a communication network, the communication device comprising:
a designation receiving unit being configured to receive a specification of an IP address from outside the communication device;
a memory being configured to store at least one private address assigned to at least one other device on the communication network;
a determination unit configured to determine agreement or disagreement between the IP address received by the designation receiving unit and the private address; and
an annunciation unit being configured to annunciate disagreement between the IP address received by the designation receiving unit does and the private address when determined by the determination unit.

2. The communication device according to claim 1, wherein the annunciation unit is a display unit configured to display the IP address received by the designation receiving unit in a predetermined color, and at the same time display the IP address received by the designation receiving unit in a color different from the predetermined color when the IP address received by the designation receiving unit does not agree with the private address.

3. A communication device configured to communicate with other devices connected to a communication network, the communication device comprising:
a designation receiving unit being configured to receive a specification of an IP address from outside the communication device;
a memory being configured to store a network address of its own device;
a network address specification unit configured to specify a network address corresponding to the IP address based on the IP address received by the designation receiving unit;
a determination unit being configured to determine agreement and disagreement between the network address specified by the network address specification unit and the network address of its own device stored by the memory agree; and
an annunciation unit being configured to annunciate disagreement between the network address specified and the network address of its own device when determined by the determination unit.

4. The communication device according to claim 3, wherein the annunciation unit is a display unit configured to display the IP address received by the designation receiving unit in a predetermined color, and at the same time display the IP address received by the designation receiving unit in a color different from the predetermined color, when the network address specified by the network address specification unit and the network address of its own device stored by the memory do not agree with each other.
